(19) United States
(12) Patent Application Publication
(10) Pub. No.: US 2019/0335047 A1
(43) Pub. Date: Oct. 31, 2019

(54) SERVER, IMAGE FORMING SYSTEM, AND MANAGEMENT METHOD CAPABLE OF MANAGING USERS OF IMAGE FORMING APPARATUSES IN HIERARCHICAL GROUPS

(71) Applicant: KYOCERA Document Solutions Inc., Osaka (JP)

(72) Inventor: Tan Jaclyn Tiffanie, Osaka (JP)

(73) Assignee: KYOCERA Document Solutions Inc., Osaka (JP)

(21) Appl. No.: 16/393,500

(22) Filed: Apr. 24, 2019

(30) Foreign Application Priority Data
Apr. 27, 2018 (JP) 2018-086382

(51) Int. Cl. H04N 1/00

(52) U.S. Cl. CPC H04N 1/00511; H04N 1/00244; H04N 2201/0094; H04N 1/00464; H04N 1/00506

(57) ABSTRACT

Provided is a server of an image forming system capable of customizing a user interface. A hierarchy classifying unit classifies groups in which users related to management of the image forming apparatuses are integrated in hierarchies. An interface setting unit sets customized user interfaces so as to have different appearances corresponding to the hierarchies classified by the hierarchy classifying unit. An interface providing unit provides the user interface set by the interface setting unit when a user logs in. This customization includes a product name, a product logo, a favicon, and web page color design.

### INCORPORATION BY REFERENCE

This application is based on and claims the benefit of priority from Japanese Patent Application No. 2018-086382 filed on Apr. 27, 2018, the contents of which are hereby incorporated by reference.

### BACKGROUND

The present disclosure relates to a server, an image forming system and a management method, and more particularly to a server, an image forming system and a management method capable of managing users of image forming apparatuses in hierarchical groups.

There are image forming apparatuses such as MFP (multifunctional peripheral) and the like capable of printing documents and images. In recent years, in business offices of most companies and the like, a plurality of image forming apparatuses are installed in the office.

Conventionally, there are image forming systems that manage these image forming apparatuses.

Image forming apparatuses are used by various business establishments and people in these kinds of image forming systems.

In these conventional image forming systems, companies and the like are classified as groups in the system in order to distinguish and manage business and the like using the same system. On this basis, each user of the image forming system is granted access rights only to the respective groups to which each user belongs.

In a typical technology, there is a license management server. The license management server includes a license management DB, a group management DB, a group recognizing unit, and a license managing unit. The license management DB stores information related to licenses for performing remote maintenance and the like on one or more image forming apparatuses installed at a customer site. The group management DB stores information regarding groups representing organizations that will make a contract for acquiring a license, and group types indicating the types of groups. The group recognizing unit extracts a group from the group management DB. The license managing unit determines the group type of the extracted group, and grants a license based on the determined group type.

In this typical technique, groups are hierarchically managed in a tree structure.

### SUMMARY

The server according to the present disclosure is a server of an image forming system for managing image forming apparatuses. The server includes a hierarchy classifying unit, an interface setting unit, and an interface providing unit. The hierarchy classifying unit classifies groups in which users related to management of the image forming apparatuses are integrated in a tree structure. The interface setting unit sets a user interface for which customization has been performed so as to have a different appearance corresponding to the hierarchy of the tree structure of the groups classified by the hierarchy classifying unit. The interface providing unit provides the user interface set by the interface setting unit when a user logs in. The customization includes a product name, a product logo, a favicon, and a color design on a web page.

The image forming system according to the present disclosure is an image forming system for managing image forming apparatuses, including image forming apparatuses, terminals, and a server. The server includes a hierarchy classifying unit, an interface setting unit, and an interface providing unit. The hierarchy classifying unit classifies groups in which users related to management of the image forming apparatuses are integrated in a tree structure. The interface setting unit sets a user interface for which customization has been performed so as to have a different appearance corresponding to the hierarchy of the tree structure of the groups classified by the hierarchy classifying unit. The interface providing unit provides the user interface set by the interface setting unit when a user logs in from a terminal. The customization includes a product name, a product logo, a favicon, and a color design on a web page.

The management method according to the present disclosure is a management method executed by a server of an image forming system for managing image forming apparatuses. The server classifies groups in which users related to management of the image forming apparatuses are integrated in a tree structure. The server sets a user interface for which customization has been performed so as to have a different appearance corresponding to the hierarchy of the tree structure of the classified groups. The customization includes a product name, a product logo, a favicon, and a color design on a web page. The server provides the set user interface when the user logs in.

### BRIEF DESCRIPTION OF THE DRAWINGS

FIG. 1 is a system configuration diagram of an image forming system of an embodiment according to the present disclosure.

FIG. 2 is a block diagram illustrating a control configuration of the server illustrated in FIG. 1.

FIG. 3 is a block diagram illustrating a functional configuration of the image forming system of an embodiment according to the present disclosure.

FIG. 4 is a flowchart of a UI customization process of an embodiment according to the present disclosure.

FIG. 5 is a conceptual diagram of the hierarchy classification process illustrated in FIG. 4.

FIG. 6A is a conceptual diagram of the interface setting process illustrated in FIG. 4.

FIG. 6B is a conceptual diagram of the interface setting process illustrated in FIG. 4.

FIG. 7 is a screen example of the interface providing process shown in FIG. 4.

### DETAILED DESCRIPTION

### Embodiments

### [System Configuration of Image Forming System X]

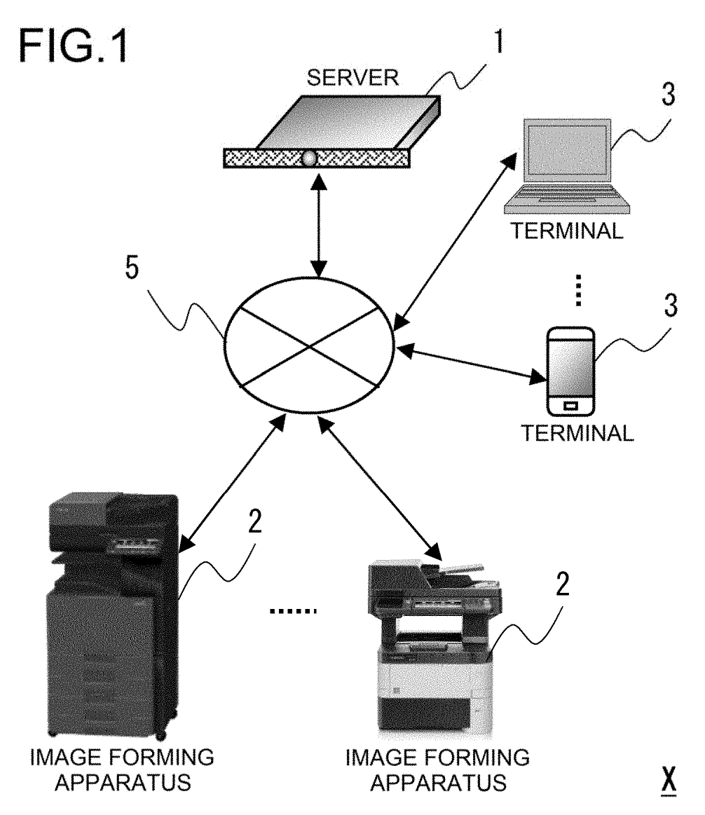

First, the system configuration of the image forming system X of an embodiment according to the present disclosure will be described with reference to FIG. 1.

The image forming system X of the present embodiment includes a server 1, image forming apparatuses 2, and terminals 3.

The server 1 is an information processing apparatus such as a PC (Personal Computer), a general-purpose machine or the like and manages the image forming apparatuses 2. The server 1 remotely manages each image forming apparatus 2, and mainly performs billing, maintenance, and service correspondence. The server 1 may also be a server on a so-called “cloud”.

Incidentally, in the present embodiment, the server 1 may execute a service (service, daemon) for transmitting and receiving e-mails or messages by various messengers (hereinafter simply referred to as “e-mails”) for notifying customers.

In addition, the server 1 may execute image processing, OCR (Optical Character Recognition) processing, classification processing, transmission processing to an e-mail or shared folder (document box, storage folder), business or office DMS (Document Management System) and the like.

The image forming apparatuses 2 are information processing apparatuses such as an MFP, a network scanner, a document scanner, a network FAX, a printer, or the like. In addition, the image forming apparatuses 2 may also perform copying (copying), printing, scanning, facsimile transmission, and the like of a document.

The terminals 3 are terminals used by users related to management of the image forming apparatuses 2. Such a user may be a customer, a service person, a support staff member, an administrator or the like.

More specifically, a terminal 3 is a PC, a mobile phone, a smartphone, a tablet, a PDA (Personal Data Assistant), a business support terminal, a dedicated terminal, or the like. In addition, the terminals 3 operate using various general-purpose OS (Operating Systems) and the like. Moreover, on the terminals 3, various application software (Application Software, applications, hereinafter simply referred to as “apps”) may be installed.

The network 5 is a LAN (Local Area Network), or a WAN (Wide Area Network) such as the Internet, a mobile phone network or the like. Further, the network 5 may be a voice telephone line, a dedicated line, or the like. In addition, the network 5 may be configured to be connected to a WAN via another network. Further, the network 5 may form a VPN (Virtual Private Network).

### (Control Configuration of Server 1)

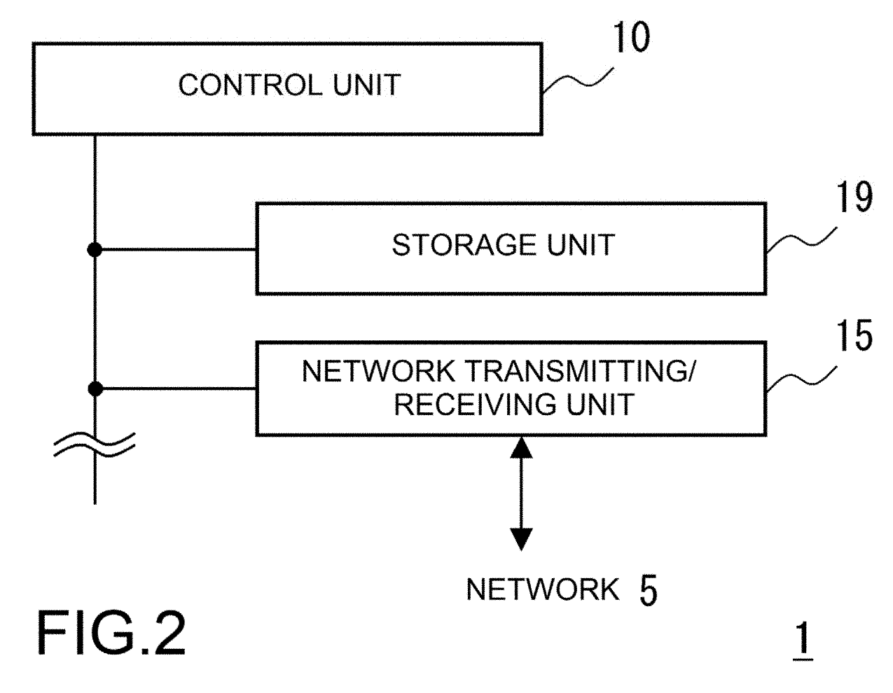

Next, the control configuration of the server 1 will be described with reference to FIG. 2.

The server 1 includes a control unit 10, a network transmitting/receiving unit 15, a storage unit 19, and the like. Each unit is connected to the control unit 10, and the operation thereof is controlled by the control unit 10.

The control unit 10 is an information processing unit such as a GPP (General Purpose Processor), a CPU (Central Processing Unit), a MPU (Micro Processing Unit), a DSP (Digital Signal Processor), a GPU (Graphics Processing Unit), an ASIC (Application Specific Integrated Circuit, application specific processor) or the like.

The control unit 10 reads a control program stored in the ROM or the HDD of the storage unit 19, develops the control program in the RAM, and executes the control program to operate as each unit of functional blocks described later.

The network transmitting/receiving unit 15 is a network connecting unit including a LAN board, a wireless transceiver, or the like for connecting to an external network such as a LAN, a wireless LAN, a WAN, a mobile phone network, and the like.

The network transmitting/receiving unit 15 transmits and receives data on a data communication line, and transmits and receives voice signals on a voice telephone line.

The storage unit 19 is a non-transitory recording medium such as a semiconductor memory such as ROM (Read Only Memory), RAM (Random Access Memory) or the like, a HDD (Hard Disk Drive), or the like.

A control program for performing operation control of the server 1 is stored in the ROM or the HDD of the storage unit 19. In addition to this, the storage unit 19 also stores the account settings 200 of the users. Moreover, the storage unit 19 may include a storage folder area for each user.

Incidentally, in the server 1, the control unit 10 may be integrally formed, such as a CPU with built-in GPU, a chip-on-module package, an SOC (System On a Chip), or the like.

Moreover, the control unit 10 may be internally equipped with a RAM, a ROM, a flash memory, or the like.

### [Functional Configuration of Server 1]

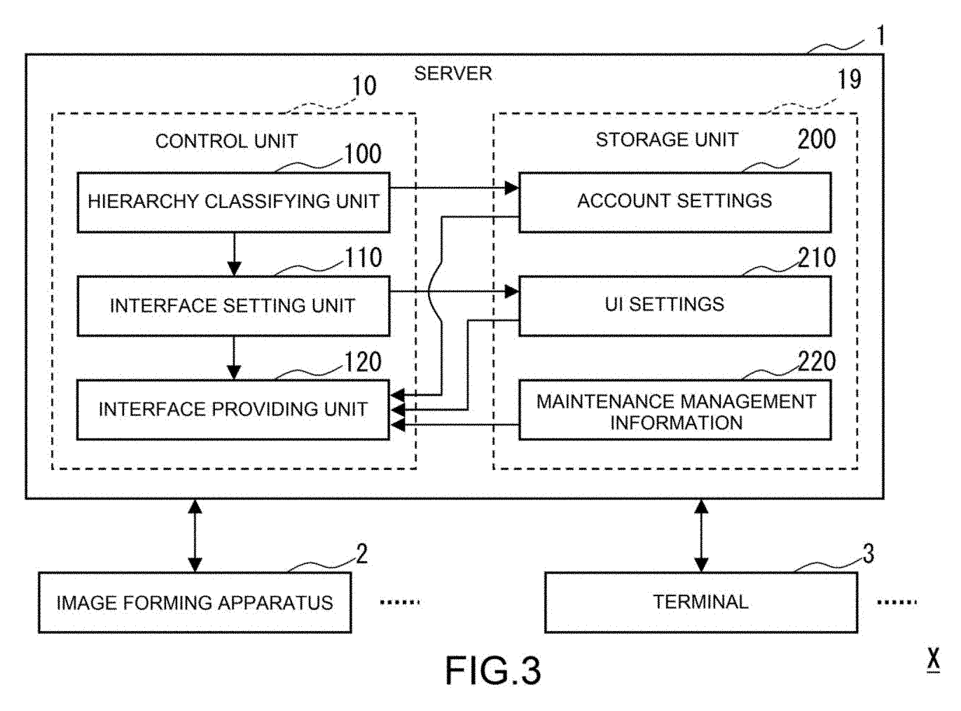

Here, the functional configuration of the server 1 of the image forming system X of an embodiment according to the present disclosure will be described with reference to FIG. 3.

The control unit 10 of the server 1 includes a hierarchy classifying unit 100, an interface setting unit 110, and an interface providing unit 120.

The storage unit 19 stores account settings 200, UI settings 210, and maintenance management information 220.

The hierarchy classifying unit 100 classifies groups in which users related to the management of the image forming apparatuses are integrated in a tree structure. In this tree structure, it is classified according to the relationships between upper groups and lower groups of each group. The hierarchy classifying unit 100 sets this classification in the account settings 200.

The interface setting unit 110 sets a user interface (hereinafter abbreviated as “UI”) for which customization has been performed so as to have a different appearance corresponding to the hierarchy classified by the hierarchy classifying unit 100. The interface setting unit 110 sets the UI for which customization has been performed in the UI settings 210.

When a user logs in, the interface providing unit 120 provides the UI set in the UI settings 210 by the interface setting unit 110. For example, the interface providing unit 120 dynamically reads pages using Java (registered trademark) script of the WWW server. Then, a page (hereinafter referred to as “web page”, “website”, or the like) is transmitted from the WWW web server or the like. The web page includes HTML (Hyper Text Markup Language) data, image data, a style sheet, and the like. The HTML data is configured so as to be displayable by the UI for which customization has been performed. The image data includes data of formats such as gif, jpeg, PNG, and the like. This data is such as icons including favicons, product logos, backgrounds, and the like. These can be displayed by the web browser or the like of a terminal 3.

The account settings 200 is a database that stores a user ID (Identification), a password, a license, maintenance management information, authority and permission information, and the like of the users of the terminals 3. In addition, the account settings 200 include information regarding image forming apparatuses 2 to be maintained and managed, information related to the correspondence between the users and the image forming apparatuses 2, and the like. Moreover, the account settings 200 store information regarding the groups to which each user belongs, including the tree structure.

The UI settings 210 is setting information regarding the user interfaces (UI) set by the interface setting unit 110. The UI settings 210 include various pieces of information for performing customization each hierarchy so as to have a different appearance. This customization includes the product name, product logo, favicon, and color design on web page. The UI setting 210 may include a “js” file, a CSS file, and the like corresponding to dynamic reading of Java (registered trademark) Script for each user and group.

The maintenance management information 220 is information for maintenance management of the image forming apparatuses 2. This maintenance management information may include information such as logs, diagnostic data, counts such as the number of output sheets and the like, billing, installation locations (customer environment) of the image forming apparatuses 2, customer contact information, and the like. Furthermore, the maintenance management information 220 may include information on specific content regarding failure or maintenance from the customer.

Here, the control unit 10 of the server 1, by executing the control program stored in the storage unit 19, functions as the hierarchy classifying unit 100, the interface setting unit 110, and the interface providing unit 120.

In addition, each unit of the server 1 described above is a hardware resource for executing the image forming method according to the present disclosure.

Note that a part or an arbitrary combination of the above-described functional configurations may be hardware-configured with an IC, programmable logic, FPGA (Field-Programmable Gate Array), and the like.

### [UI Customization Process by the Server 1]

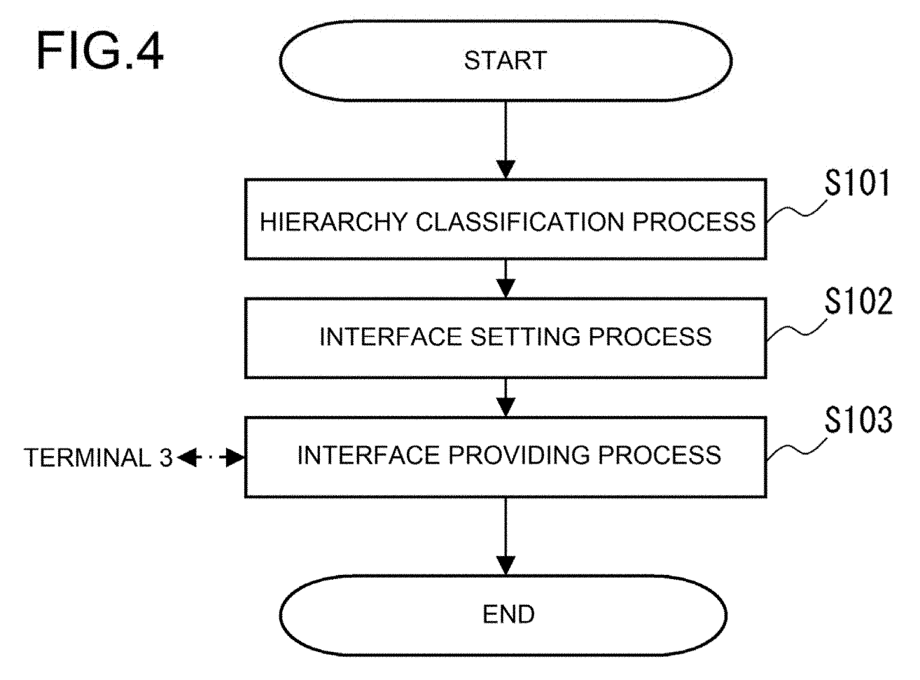

Next, the UI customization process by the server 1 of an embodiment according to the present disclosure will be described with reference to FIG. 4 to FIG. 7.

In the UI customization process according to the present embodiment, groups in which users are integrated are classified in a tree structure. Then, a user interface for which customization has been performed is set so as to have a different appearance corresponding to the hierarchy of the tree structure of the classified group. Customization at this time includes product name, product logo, favicon, and color design on the web page. Then, when the user logs in, the set user interface is provided.

In the UI customization process according to the present embodiment, the control unit 10 mainly executes the program stored in the storage unit 19 by using the hardware resources in cooperation with each unit.

Hereinafter, the details of the UI customization process of the present embodiment will be described step by step with reference to the flowchart of FIG. 4.

### (Step S101)

First, the hierarchy classifying unit 100 performs a hierarchy classification process.

In a case where there is access from management terminals of administrators or the like of the image forming system X, the hierarchy classifying unit 100 classifies users related to management of the image forming apparatuses 2 into hierarchies and sets them in the account settings 200.

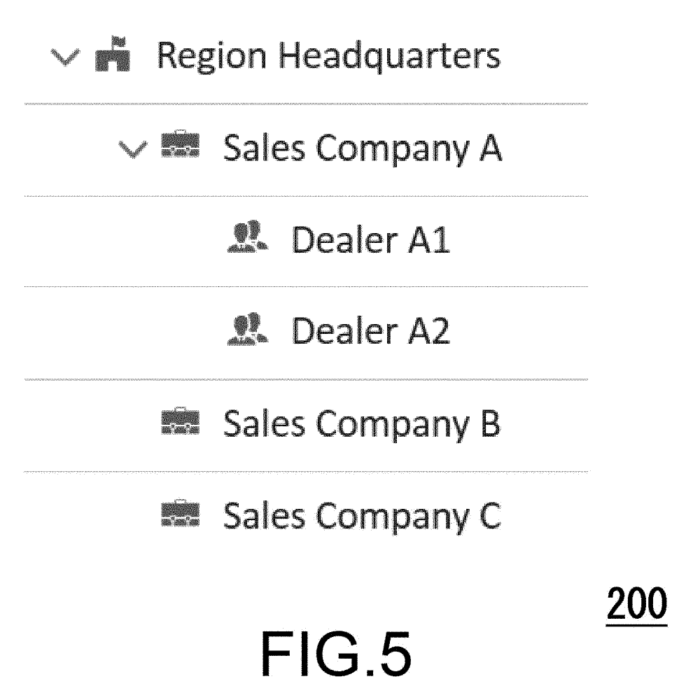

FIG. 5 illustrates an example of a hierarchy of groups set in the account settings 200.

In the image forming system X, each user is organized and managed in a tree structure group in order to meet the demands of a number of businesses.

In this example, a sales company A (Sales Company A), a sales company B (Sales Company B), and a sales company C (Sales Company C) are set as lower groups under the upper group, which is the Region Headquarters, in the account settings 200. Furthermore, a dealer A1 and dealer A2 are set as lower groups of sales company A.

### (Step S102)

Next, the interface setting unit 110 performs an interface setting process.

The interface setting unit 110 sets the UI in the UI settings 210 in correspondence to the hierarchy of the tree structure of the groups set in the account settings 200. Customization has been performed for this UI to have a different appearance corresponding to the above classification.

Here, the interface setting unit 110 may perform customization of the UI by three methods: customization of an upper group, customization by an administrator, and customization by a user.

The customization of the upper group is the default (prescribed) customization for all groups of the image forming system X. In the case where an upper group performs customization of the UI, the users belonging to a lower group may browse the web page with the same UI. For example, in a case where the sales company A performs customization of the UI, the dealer A1 and the dealer A2, which are lower groups of the sales company A, have the same UI. Note that, in a case where further customization is performed by another method described below, the UI becomes different.

In customization by an administrator, it is possible to allow a lower group to not use the same UI as an upper group. In this case, it is also possible to return to the default UI of the image forming system X.

In customization by a user, it is possible for a lower group to perform customization of their own group because of their own branding.

In this way, although the interface setting unit 110 prioritizes the customization of an upper hierarchy by an upper group over the customization of a lower hierarchy by a lower group, interface setting unit 110 permits customization by an administrator and customization by a user himself/herself.

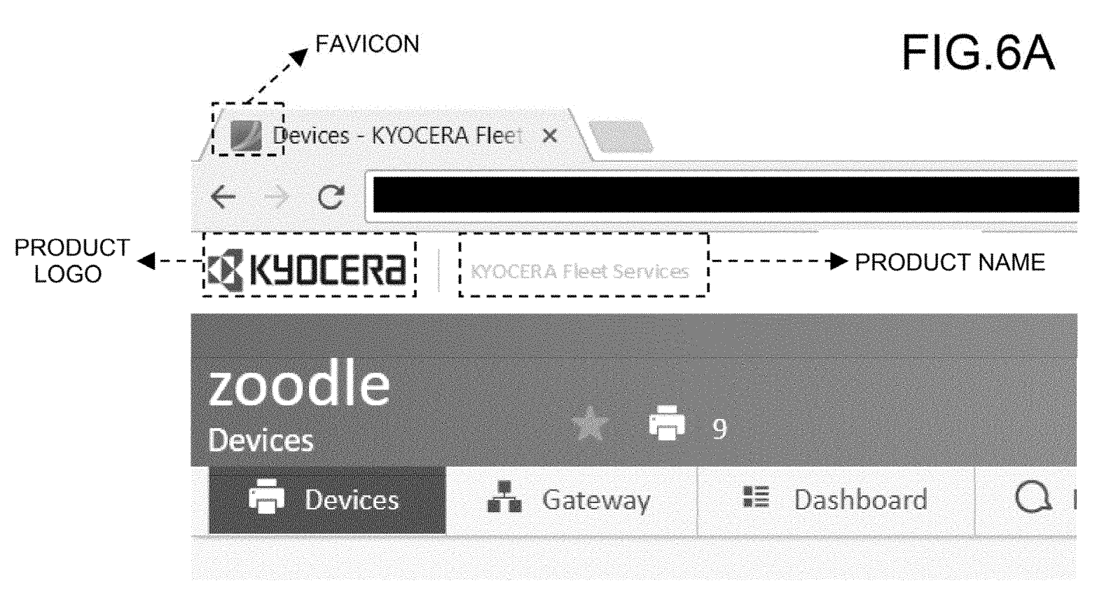

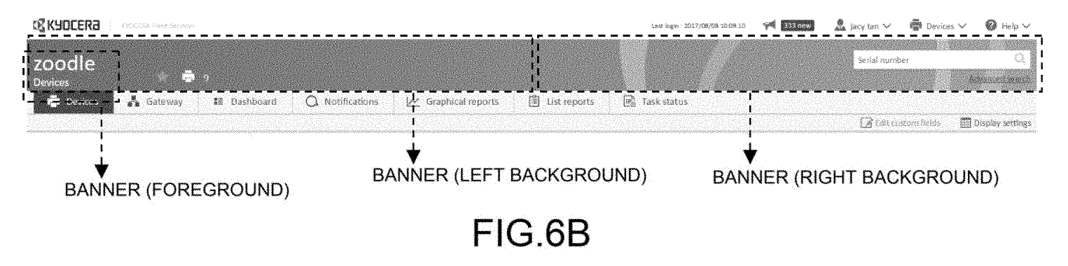

Next, with reference to the specific examples of FIG. 6A and FIG. 6B, parts of customization of the UI will be described.

The interface setting unit 110 may perform UI customization of a part including a product name, a product logo, a favicon, and a color design on a web page when browsing the image forming system X.

According to FIG. 6A and FIG. 6B, the interface setting unit 110 may perform customization of a part including the product name, product logo, favicon, and color design on a web page for each group of businesses. Among these, a favicon is an icon (small image) to be placed on a website or a web page as a symbol mark image of the website.

In addition, regarding the color design, the interface setting unit 110 may perform customization of parts that includes a selection of a basic color (primary color), a color and a banner image of a banner (foreground), a banner (left background), a banner (right background), items selected in a list, an item hover in a table, a button hover (background), and a button hover (foreground) The color of each of these buttons includes a background color and a foreground color.

Here, in the image forming system X of the present embodiment, an upper group performs more management of a lower group than the users of the lower group themselves.

Therefore, for an upper group, the interface setting unit 110 may also limit the UI area that a lower level group may perform customization.

For example, an upper group may force lower groups to use a product logo that is provided.

In this case, the interface setting unit 110 may also restrict a lower group from modifying a logo and allow only customization of other areas that is able to perform customization.

### (Step S103)

Next, the interface providing unit 120 performs an interface providing process.

When a user logs in through a terminal 3, the interface providing unit 120 reads the account settings 200 and the UI settings 210, and transmits the web page with the UI corresponding to the logged-in user. As a result, the interface providing unit 120 may provide a user interface that is set by the interface setting unit 110.

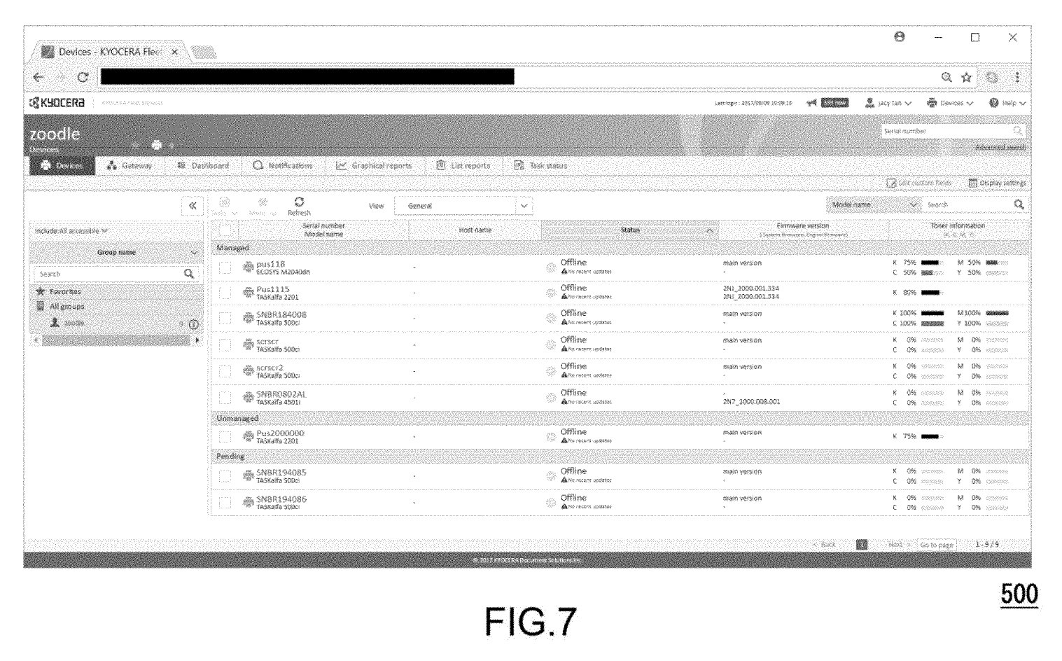

FIG. 7 illustrates a screen example of a provided UI.

This ends the UI customization process of an embodiment according to the present disclosure.

With a configuration as described above, the following effects may be obtained.

Conventionally, some sales companies and dealers that use image forming systems have a desire to perform customization of a UI in order to make it appear to be supplied to users as their own product. However, with the typical technique described above, such customization was not possible.

On the other hand, the server 1 of an embodiment according to the present disclosure is a server of an image forming system X that manages image forming apparatuses 2, and includes: a hierarchy classifying unit 100 for classifying groups in which users related to management of the image forming apparatuses 2 are integrated into hierarchies; an interface setting unit 110 for setting a user interface for which customization has been performed so as to have a different appearance corresponding to the hierarchies classified by the hierarchy classifying unit 100; and an interface providing unit 120 for providing a user interface set by the interface setting unit 110 when a user logs in from a terminal 3; wherein the customization includes a product name, a product logo, a favicon, and a color design on the web page.

With this kind of configuration, a sales company or dealer can perform customization of parts of a UI such as a product name, a product logo, a favicon, and a color design or the like. In other words, when setting up many groups representing offices using a system, by performing customization of the appearance of the system, each of these offices will provide products with a UI corresponding to their own brand, and may establish a brand.

In addition, although the server 1 of an embodiment according to the present disclosure prioritizes customization of an upper hierarchy over a lower hierarchy, the server 1 also allows customization by an administrator and customization by a user himself/herself.

With this kind of configuration, by performing customization of a UI based on a default (prescribed) setting or a setting of an upper group, customization of part of a UI corresponding to a brand of a sales company and dealer may be performed easily.

### OTHER EMBODIMENTS

Note that in the above embodiment, an example of performing customization of a UI using Java (registered trademark) Script has been described.

However, using a generator for various dynamic pages such as CGI (Common Gateway Interface), ASP, SSI (Server Side Includes), Servlet, PHP and the like, a web page with a UI for which customization has been performed may be generated and provided to a user.

Moreover, in the above-described embodiment, although an example of providing a web page by the server 1 on the cloud is described, a web page may also be provided by an image forming apparatus incorporating a web server, a server on an intranet, or the like.

Some sales companies and dealers that use a image forming system have a desire to perform customization of (make unique) the UI on the web page of the management screen of the image forming system to give an appearance of supplying to a user as one's own product.

However, with the typical technology described above, it was impossible to perform customization for each group such as sales companies, dealers or the like.

According to the present disclosure, by setting a UI so as to have a different appearance corresponding to the hierarchy of the tree structure of groups, and providing a set UI when a user logs in, it is possible to provide a server that may perform customization of the UI for each group.

In addition, the technique according to the present disclosure may also be applied to an information processing apparatus other than an image forming apparatus. In other words, a configuration using a server or the like that is separately connected to a network scanner, a scanner or the like by USB or the like may be used.

Moreover, needless to say, the configuration and operation of the above-described embodiment are examples and can be appropriately changed and executed within a range that does not depart from the gist of the present disclosure.

What is claimed is:

1. A server that is a server of an image forming system for managing image forming apparatuses, comprising:
a hierarchy classifying unit for classifying groups in which users related to management of the image forming apparatuses are integrated in a tree structure;
an interface setting unit for setting a user interface for which customization has been performed so as to have a different appearance corresponding to the hierarchy of the tree structure of the groups classified by the hierarchy classifying unit; and
an interface providing unit that provides the user interface set by the interface setting unit when a user logs in; wherein
the customization includes
a product name, a product logo, a favicon, and a color design on a web page.

2. The server according to claim 1, wherein
although the interface setting unit prioritizes the customization of an upper hierarchy over a lower hierarchy, the interface setting unit permits customization by an administrator and customization by a user himself/herself.

3. An image forming system that is an image forming system for managing image forming apparatuses, including image forming apparatuses, terminals, and a server, wherein
the server comprises:
a hierarchy classifying unit for classifying groups in which users related to management of the image forming apparatuses are integrated in a tree structure;
an interface setting unit for setting a user interface for which customization has been performed so as to have a different appearance corresponding to the hierarchy of the tree structure of the groups classified by the hierarchy classifying unit; and
an interface providing unit for providing the user interface set by the interface setting unit when the user logs in from the terminal; wherein
the customization includes
a product name, a product logo, a favicon, and a color design on a web page.

4. A management method that is a management method executed by a server of an image forming system for managing image forming apparatuses, wherein the server
classifies groups in which users related to management of the image forming apparatuses are integrated in a tree structure; and
sets a user interface for which customization has been performed so as to have a different appearance corresponding to the hierarchy of the tree structure of the classified groups; wherein
the customization includes a product name, a product logo, a favicon, and a color design on a web page; and
the server provides the set user interface when the user logs in.
